(19) United States
(12) Patent Application Publication
(10) Pub. No.: US 2007/0160296 A1
(43) Pub. Date: Jul. 12, 2007

(54) Face recognition method and apparatus

(75) Inventors: Jong-ha Lee, Hwaseong-si (KR); Gyu-tae Park, Anyang-si (KR); Seok-cheol Kee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/529,350

(22) Filed: Sep. 29, 2006

(30) Foreign Application Priority Data
Jan. 11, 2006 (KR) 10-2006-0003325

(51) Int. Cl. G06K 9/62

(52) U.S. Cl. 382/224

(57) ABSTRACT

A face recognition method and apparatus. The face recognition apparatus includes a Gabor filter unit which obtains a plurality of response values by applying a plurality of Gabor filters having different properties to a plurality of fiducial points extracted from an input face image, a linear discriminant analysis (LDA) unit which obtains first LDA results by performing LDA on each of a plurality of response value groups into which the response values of the plurality of response values are classified, a similarity calculation unit which calculates similarities between the first LDA results and second LDA results obtained by performing LDA on a face image other than the input face image, and a determination unit which classifies the input face image according to the similarities.

### CROSS-REFERENCE TO RELATED APPLICATION

This application claims priority from Korean Patent Application No. 10-2006-0003325 filed on Jan. 11, 2006 in the Korean Intellectual Property Office, the disclosure of which is incorporated herein by reference.

### BACKGROUND OF THE INVENTION

1. Field of the Invention

The present invention relates to face recognition and, more particularly, to a face recognition method and apparatus in which a plurality of response values are extracted from a face image by applying a plurality of Gabor filters to the face image, linear discriminant analysis (LDA) results are obtained by performing LDA on the response values, and similarities obtained using the LDA results are fused.

2. Description of Related Art

With the development of the information society, the importance of identification technology to identify individuals has rapidly grown, and more research has been conducted on biometric technology for protecting computer-based personal information and identifying individuals using the characteristics of the human body. In particular, face recognition, which is a type of biometric technique, uses a non-contact method to identify individuals, and is thus deemed more convenient and more competitive than other biometric techniques such as fingerprint recognition and iris recognition which require users to behave in a certain way to be recognized. Face recognition is a core technique for multimedia database searching, and is widely used in various application fields such as moving picture summarization using face information, identity certification, human computer interface (HCI) image searching, and security and monitoring systems.

However, face recognition may provide different results for different internal environments such as different user identities, ages, races, and facial expressions, and jewelry and for different external environments such as different poses adopted by users, different external illumination conditions, and different image processes. In particular, external illumination variations are likely to considerably affect the performance of face recognition systems and methods, and thus it is very important to develop face recognition algorithms that are robust against external illumination variations.

An existing face recognition method that is robust against external illumination variations is a Gabor filter method which involves the use of Gabor filters to perform face recognition. The Gabor filter method uses a mathematical modeling technique for the simple cell receptive characteristics of the human eyes, and is thus robust against external illumination variations. The Gabor filter method can be used as a face recognition algorithm, and has been widely used in various application fields.

There are no perfect features for face recognition. In general, the more the features used in face recognition, the higher the performance of face recognition becomes. However, training data is limited even when a sufficient number of features to perform face recognition exist. Consequently, existing sub-space training algorithms may not be able to properly represent a plurality of features useful for face recognition. When a sufficient amount of training data and a sufficient number of input features to perform face recognition exist, the computation burden on a training system may undesirably increase, thus making it difficult to obtain proper face recognition results.

This problem with existing face recognition techniques also arises when using Gabor filters. The more Gabor filters used, the more features can be extracted from a face image. However, the more Gabor filters used, the more difficult it becomes to perform subspace-based training on the extracted features. For this reason, conventional face recognition methods involve the use of only a limited number of Gabor filters, thus failing to utilize sufficient information to identify faces and imposing limitations on the improvement of the performance of face recognition.

### BRIEF SUMMARY

An aspect of the present invention provides a face recognition method and apparatus, in which a plurality of response values are extracted from a face image by applying a plurality of Gabor filters having different properties to the face image, linear discriminant analysis (LDA) results are obtained by performing LDA on the response values, and similarities obtained using the LDA results are fused.

According to an aspect of the present invention, there is provided a face recognition apparatus. The face recognition apparatus includes a Gabor filter unit which obtains a plurality of response values by applying a plurality of Gabor filters having different parameters to a plurality of fiducial points extracted from an input face image, a linear discriminant analysis (LDA) unit which obtains first LDA results by performing LDA on each of a plurality of response value groups into which the response values of the plurality of response values are classified, a similarity calculation unit which calculates similarities between the first LDA results and second LDA results obtained by performing LDA on a face image other than the input face image, and a determination unit which classifies the input face image according to the similarities.

According to another aspect of the present invention, there is provided a face recognition method. The face recognition method includes obtaining a plurality of response values by applying a plurality of Gabor filters having different parameters to a plurality of fiducial points extracted from an input face image, obtaining linear discriminant analysis (LDA) results by performing LDA on each of a plurality of response value groups into which the response values of the plurality of response values are classified, calculating similarities between the first LDA results and second LDA results obtained by performing LDA on a face image other than the input face image, and classifying the input face image according to the similarities.

According to another aspect of the present invention, there is provided a face recognition apparatus including: a normalization unit extracting a face image from an input image, and extracting a set of fiducial points from the extracted face image; a Gabor filter unit applying a plurality of Gabor filters having different properties to the extracted fiducial points to yield response values; a classification unit classifying the response values into at least one response value group based on the Gabor filter properties; a linear discriminant analysis (LDA) unit generating first LDA results by performing LDA on each response value group; a similarity calculation unit calculating similarities between the first LDA results and training data generated by performing LDA on a reference face image; and a determination unit classifying the input face image according to the similarities.

According to another aspect of the present invention, there is provided a computer-readable storage medium encoded with processing instructions to execute the aforementioned method.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a face recognition apparatus according to an embodiment of the present invention;

FIG. 2 is a block diagram of an image reception unit 110 illustrated in FIG. 1;

FIG. 3 presents a face image with a plurality of fiducial points;

FIG. 4 is a block diagram of a normalization unit 120 illustrated in FIG. 1;

FIGS. 5A and 5B are tables presenting sets of Gabor filters according to an embodiment of the present invention;

FIG. 6 is a block diagram of a linear discriminant analysis (LDA) unit 150 and a similarity calculation unit 160 illustrated in FIG. 1;

FIG. 7 is a block diagram for explaining a method of fusing similarities according to an example of an embodiment of the present invention;

FIG. 8 is a block diagram for explaining a method of fusing similarities according to another example of an embodiment of the present invention;

FIG. 9 is a block diagram for explaining a method of fusing similarities according to another example of an embodiment of the present invention;

FIG. 10 is a graph illustrating experimental results obtained using a plurality of Gabor filters according to an embodiment of the present invention;

FIG. 11 is a graph illustrating face recognition rates obtained when using 7 scale channels separately;

FIG. 12 is a graph illustrating face recognition rates obtained when using 8 orientation channels separately;

FIG. 13 is a table presenting performance measurements of a face recognition apparatus and method according to an embodiment of the present invention; and

FIG. 14 is a flowchart illustrating a face recognition method according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

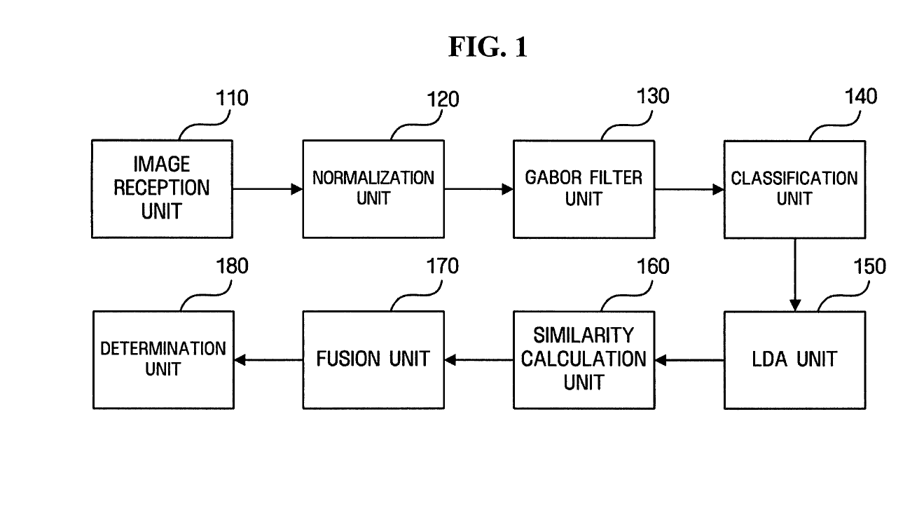

FIG. 1 is a block diagram of a face recognition apparatus according to an embodiment of the present invention. Referring to FIG. 1, the face recognition apparatus includes an image reception unit 110, a normalization unit 120, a Gabor filter unit 130, a classification unit 140, a linear discriminant analysis (LDA) unit 150, a similarity calculation unit 160, a fusion unit 170, and a determination unit 180.

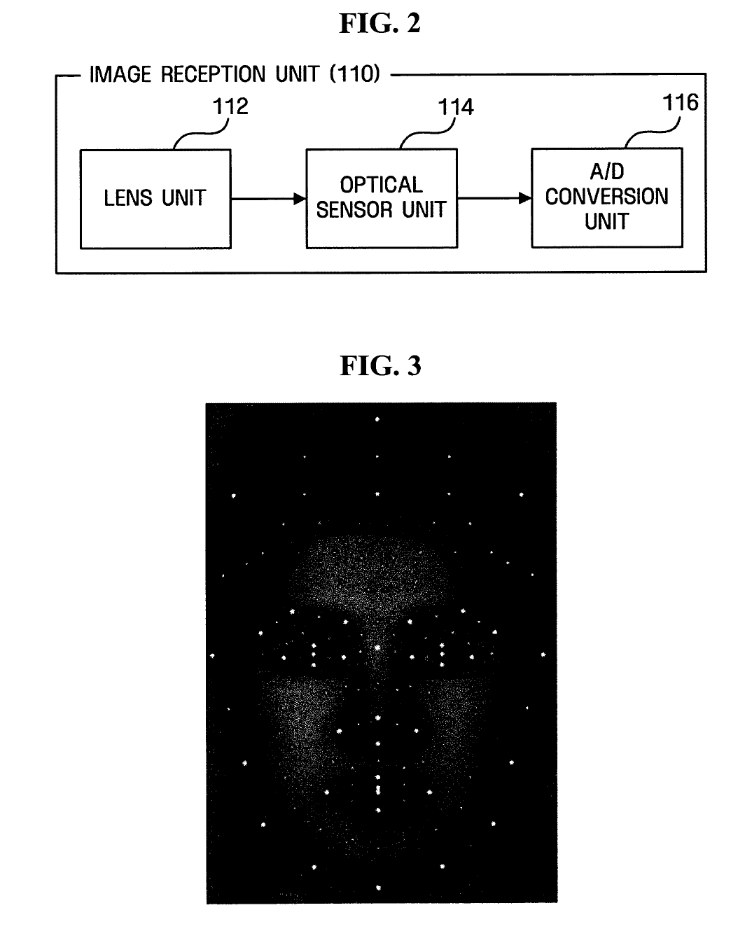

The image reception unit 110 receives an input image that renders (i.e., comprises) a face, converts the input image into pixel value data, and provides the pixel value data to the normalization unit 120. To this end, referring to FIG. 2, the image reception unit 110 includes a lens unit 112 through which the input image is transmitted, an optical sensor unit 114 which converts an optical signal corresponding to the input image transmitted through the lens unit 112 into an electrical signal (i.e., an image signal), and an analog-to-digital (A/D) conversion unit 116 which converts the electrical signal into a digital signal. The optical sensor unit 114 performs a variety of functions such as an exposure function, a gamma function, a gain control function, a white balance function, and a color matrix function, which are normally performed by a camera. The optical sensor unit 114 may be, by way of non-limiting examples, a charge coupled device (CCD) or a complementary metal oxide semiconductor (CMOS) device. The image reception unit 110 may obtain image data, which is converted into pixel value data, from a storage medium and provide the pixel image data to the normalization unit 120.

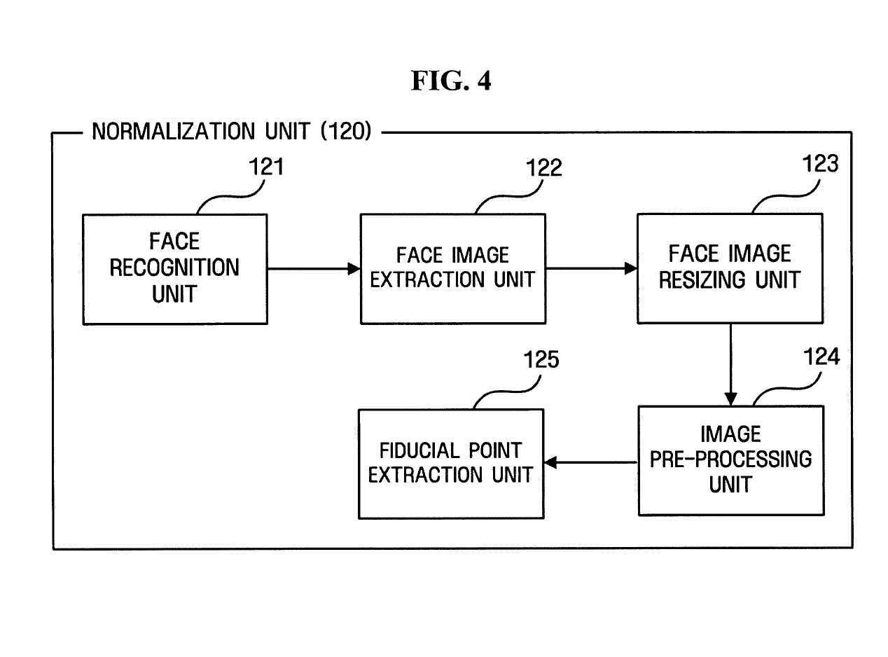

The normalization unit 120 extracts a face image from the input image, and extracts a plurality of fiducial points (fixed points for comparison) from the face image. An example of a face image comprising a plurality of fiducial points is illustrated in FIG. 3.

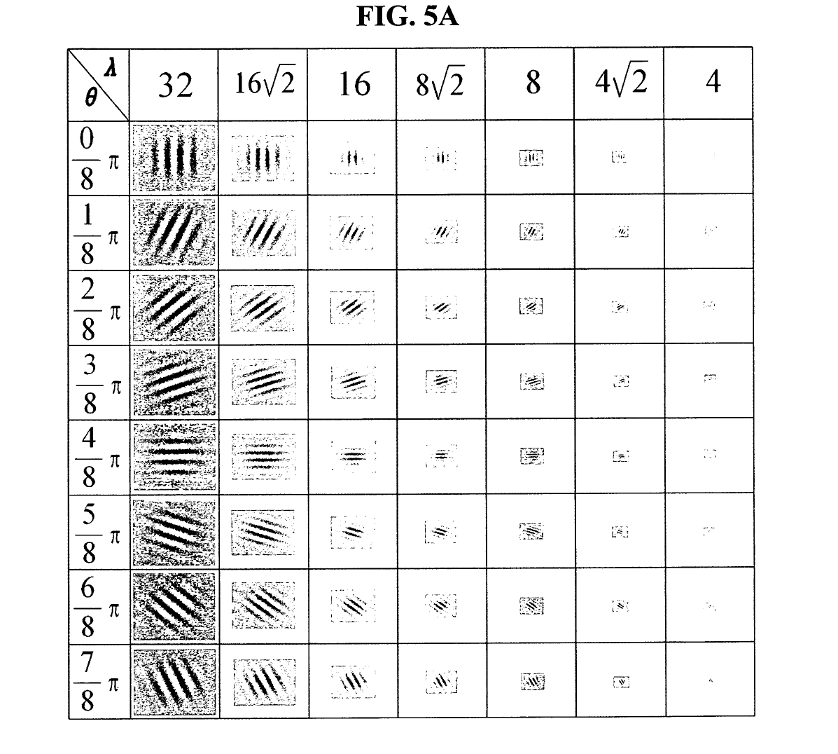

Referring to FIG. 4, the normalization unit 120 includes a face recognition unit 121, a face image extraction unit 122, a face image resizing unit 123, an image pre-processing unit 124, and a fiducial point extraction unit 125.

The face recognition unit 121 detects a predetermined region in the input image, which is represented as pixel value data. For example, the face recognition unit 121 may detect a portion of the input image comprising the eyes and use the detected portion to extract a face image from the input image.

The face image extraction unit 122 extracts a face image from the input image with reference to the detected portion provided by the face recognition unit 121. For example, if the face recognition unit 121 detects the positions of the left and right eyes rendered in the input image, the face image extraction unit 122 may determine the distance between the left and right eyes in the input image. If the distance between the eyes in the input image is 2D, the face image extraction unit 122 extracts a rectangle whose left side is D distant apart from the left eye, whose right side is D distant apart from the right eye, whose upper side is 1.5*D distant apart from a line drawn through the left and right eyes, and whose lower side is 2*D distant apart from the line drawn through the left and right eyes from the input image as a face image. In this manner, the face image extraction unit 122 can effectively extract a face image that includes all the facial features of a person (e.g., the eyebrows, the eyes, the nose, and the lips) from the input image while being less affected by variations in the background of the input image or in the hairstyle of the person. However, it is to be understood that this is only a non-limiting example. Indeed, it is contemplated that the face image extraction unit 122 may extract a face image from the input image using a method other than the one set forth herein.

The face image resizing unit 123 resizes the face image obtained by the face image extraction unit 122 to a specified size, thereby preventing Gabor filter responses from being affected by the size of the original input image. The specified size may be experimentally determined in advance.

The image pre-processing unit 124 reduces the influence of illumination on the face image provided by the face image resizing unit 123. A plurality of input images may have different brightnesses according to their illumination conditions, and a plurality of portions of an input image may also have different brightnesses according to their illumination conditions. Illumination variations may make it difficult to extract a plurality of features from a face image. Therefore, in order to reduce the influence of illumination variations, the image pre-processing unit 124 may obtain a histogram by analyzing the distribution of pixel brightnesses in a face image, and smooth the histogram around the pixel brightness with the highest frequency.

The fiducial point extraction unit 125 extracts a specified number of fiducial points, to which a Gabor filter is to be applied, from the face image pre-processed by the image pre-processing unit 124. It may be determined which points in the pre-processed face image is to be determined as a fiducial point according to experimental results obtained using face images of various people. For example, a point in face images of different people which results in a difference of a predefined value or greater between Gabor filter response values may be determined as a fiducial point. An arbitrary point in a face image may be determined as a fiducial point. However, according to the present embodiment, a point in the face images of different people which can result in Gabor filter responses that can help clearly distinguish the face images of the different people from one another is determined as a fiducial point, thereby enhancing the performance of face recognition.

It is to be understood that the structure and operation of the normalization unit 120 described above with reference to FIG. 4 is merely a non-limiting example.

Referring to FIG. 1, the Gabor filter unit 130 applies a plurality of Gabor filters having different properties to the fiducial points in the face image, thereby obtaining a plurality of response values. The properties of a Gabor filter are determined according to one or more parameters of the Gabor filter. In detail, the properties of a Gabor filter are determined according to the orientation, scale, Gaussian width, and aspect ratio of the Gabor filter.

In general, a Gabor filter may be defined as indicated by Equation (1):

$$W = {e}^{- \frac{{x}^{′ 2} + {γ}^{2} {y}^{′ 2}}{2 {σ}^{2}}} cos ( 2 π \frac{{x}^{′}}{λ} + ϕ ) . \qquad ( 1 )$$

### Here, x′=x cos θ+γ sin θ, y′=−x sin θ+γ cos θ, and θ, λ, σ, and γ respectively represent the orientation, scale, Gaussian width, and aspect ratio of a Gabor filter.

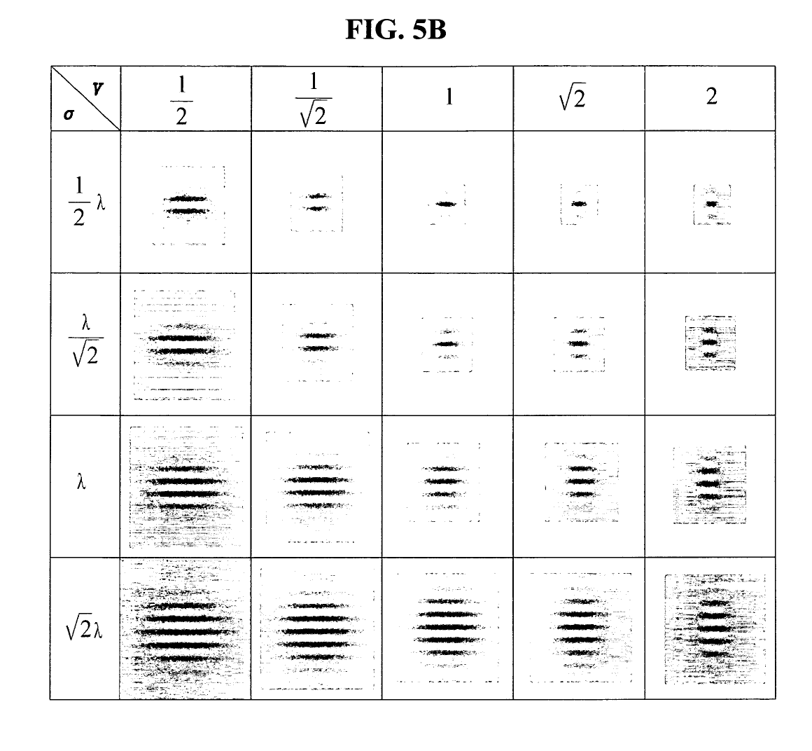

Sets of Gabor filters that can be applied to one or more fiducial points in a face image by the Gabor filter unit 130 will hereinafter be described in detail with reference to FIGS. 5A and 5B.

FIG. 5A is a table presenting a set of Gabor filters according to an embodiment of the present invention. Referring to FIG. 5A, the Gabor filters are classified according to their orientations and scales. In the present embodiment, a total of 56 Gabor filters can be obtained using 7 scales and 8 orientations.

According to the present embodiment, parameters such as Gaussian width and aspect ratio, which are conventionally not considered are used to design Gabor filters, and this will hereinafter become more apparent by referencing FIG. 5B. Referring to FIG. 5B, a plurality of Gabor filters having an orientation θ of 4/8π and a scale λ of 32 are further classified according to their Gaussian widths and aspect ratios. In other words, a total of 20 Gabor filters can be obtained using four Gaussian widths and five aspect ratios.

Accordingly, a total of 1120 (56*20) Gabor filters can be obtained from the 56 Gabor filters illustrated in FIG. 5A by varying the Gaussian width and aspect ratio of the 56 Gabor filters, as illustrated in FIG. 5B.

It is to be understood that the Gabor filter sets illustrated in FIGS. 5A and 5B are merely non-limiting examples, and that other types of Gabor filters may be used by the Gabor filter unit 130. In other words, the Gabor filters used by the Gabor filter unit 130 may have different parameter values from those set forth herein, or the number of Gabor filters used by the Gabor filter unit 130 may be different from the one set forth herein.

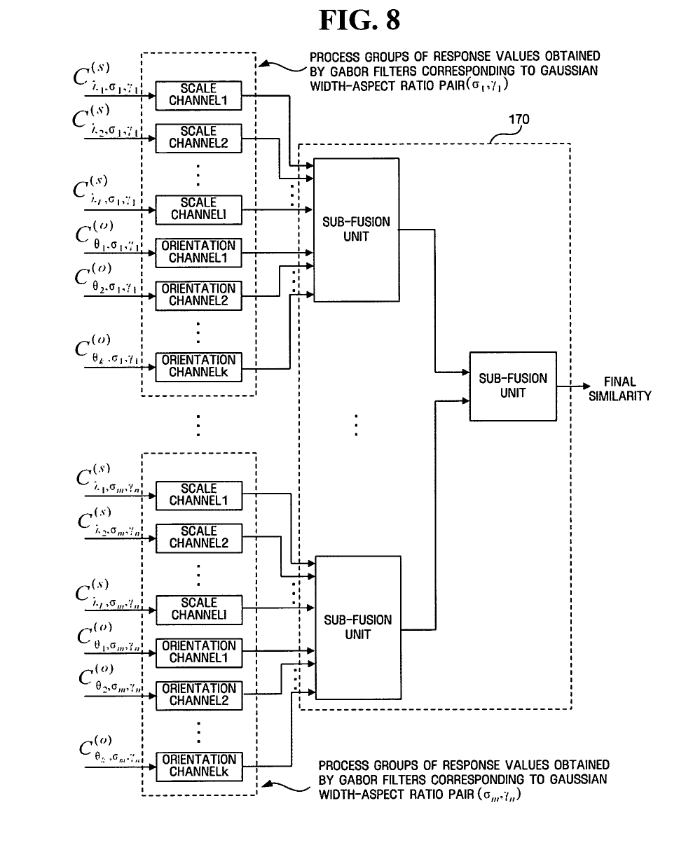

The greater the number of Gabor filters used by the Gabor filter unit 130, the heavier the computation burden on the face recognition apparatus. Thus, it is necessary to choose Gabor filters that are experimentally determined to considerably affect the performance of the face recognition apparatus, and allow the Gabor filter unit 130 to use only the chosen Gabor filters. This will be described later in further detail with reference to FIG. 8.

The response values obtained by the Gabor filter unit 130 represent the features of the face image, and may be represented as a Gabor jet set J, as indicated by Equation (2):

S={J_{θ,λ,σ,γ}(x):θ∈{θ₁, . . . θₖ}, λ∈{λ₁, . . . ,λ₁}, σ∈{σ₁, . . . , σₘ}, (2)

γ∈{γ₁, . . . , γₙ}, x∈{x₁, . . . , x_{α}}}

### Here, θ, λ, σ, and γ respectively represent the orientation, scale, Gaussian width, and aspect ratio of a Gabor filter, and x represents a fiducial point.

The classification unit 140 classifies the response values obtained by the Gabor filter unit 130 into one or more response value groups. Also, a single response value may belong to one or more response value groups.

The classification unit 140 may classify the response values obtained by the Gabor filter unit 130 into one or more response value groups according to the Gabor filter parameters used to generate the response values. For example, the classification unit 140 may provide a plurality of response value groups, each response value group comprising a plurality of response values corresponding to the same orientation and the same scale, for each of a plurality of pairs of Gaussian widths and aspect ratios used by the Gabor filter unit 130. For example, if the Gabor filter unit 130 uses four Gaussian widths and five aspect ratios, as illustrated in FIG. 5B, a total of 20 Gaussian width-aspect ratio pairs can be obtained. If the Gabor filter unit 130 uses 8 orientations and 7 scales, as illustrated in FIG. 5A, 8 response value groups corresponding to the same orientation may be generated for each of the 20 Gaussian width-aspect ratio pairs, and 7 response value groups corresponding to the same scale may be generated for each of the 20 Gaussian width-aspect ratio pairs. In other words, 56 response value groups may be generated for each of the 20 Gaussian width-aspect ratio pairs, and thus, the total number of response value groups generated by the classification unit 140 equals 1120 (20*56). The 1120 response value groups may be used as features of a face image.

Examples of the response value groups provided by the classification unit 140 may be represented by Equation (3):

C_{λ,σ,γ}^{(s)}={J_{θ,λ,σ,γ}(x):θ∈{θ₁, . . . , θₖ}, x∈{x₁, . . . , x_{α}}} (3)

C_{θ,σ,γ}^{(o)}={J_{θ,λ,σ,γ}(x):λ∈{λ₁, . . . , λₗ}, x∈{x₁, . . . , x_{α}}}

Here, C represents a response value group, parenthesized superscript s and parenthesized superscript o indicate an association with scale and orientation, respectively, and λ, σ, and γ respectively represent the orientation, scale, Gaussian width, and aspect ratio of a Gabor filter, and x represents a fiducial point.

The classification unit 140 may classify the response values obtained by the Gabor filter unit 130 in such a manner that a plurality of response values obtained from one or more predefined fiducial points can be classified into a separate response value group.

It is possible to reduce the number of dimensions of input values for LDA and thus facilitate the expansion of Gabor filters by classifying the response values obtained by the Gabor filter unit 130 into one or more response value groups in the aforementioned manner. For example, even when the number of features of a face image is increased by varying Gaussian width and aspect ratio and thus increasing the number of Gabor filters, the computation burden regarding LDA training can be reduced, and the efficiency of the LDA training can be enhanced by classifying the response values (i.e., the features of the input face image) obtained by the Gabor filter unit 130 into one or more response value groups and thus reducing the number of dimensions of input values.

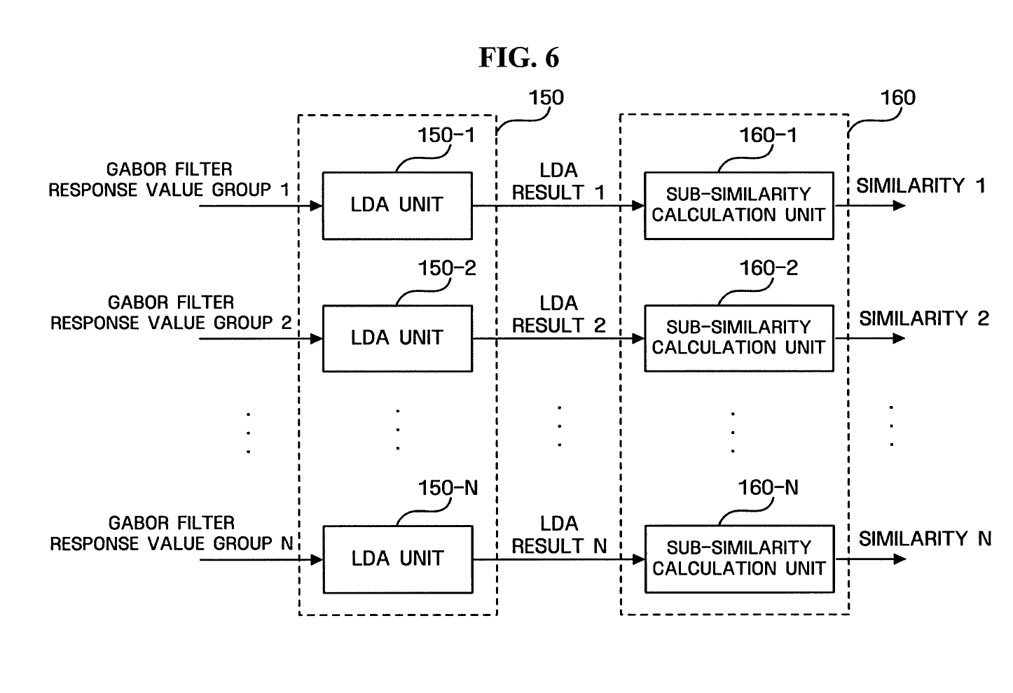

The LDA unit 150 receives the response value groups obtained by the classification unit 140, and performs LDA. In detail, the LDA unit 150 performs LDA on each of the received response value groups. For this, the LDA unit 150 may include a plurality of LDA units 150-1 through 150-N, as illustrated in FIG. 6. The LDA units 150-1 through 150-N respectively perform LDA on the received response value groups. Accordingly, the LDA unit 150 may output multiple LDA results for a single face image. According to the present embodiment, a subspace training algorithm other than LDA may be used. In this case, the LDA unit 150 may be replaced with a functional block that employs a subspace training algorithm other than LDA.

The similarity calculation unit 160 compares the LDA results output by the LDA unit 150 with LDA training results obtained by performing LDA on a reference face image, and calculates a similarity for the LDA results output by the LDA unit 150 according to the results of the comparison. Here, the reference face image is a face image that is compared with an input face image to be recognized and is used to determine whether a person rendered in the input face image is the same as a person rendered in the reference face image. According to the present embodiment, an input image comprising the reference face image is sequentially processed by the image reception unit 110, the normalization unit 120, the Gabor filter unit 130, the classification unit 140, and the LDA unit 150, thereby obtaining LDA training results. The LDA training results are stored and are compared with LDA results obtained by processing an input face image to be recognized.

In order to calculate the similarities, the similarity calculation unit 160 may include a plurality of sub-similarity calculation units 160-1 through 160-N, as illustrated in FIG. 6.

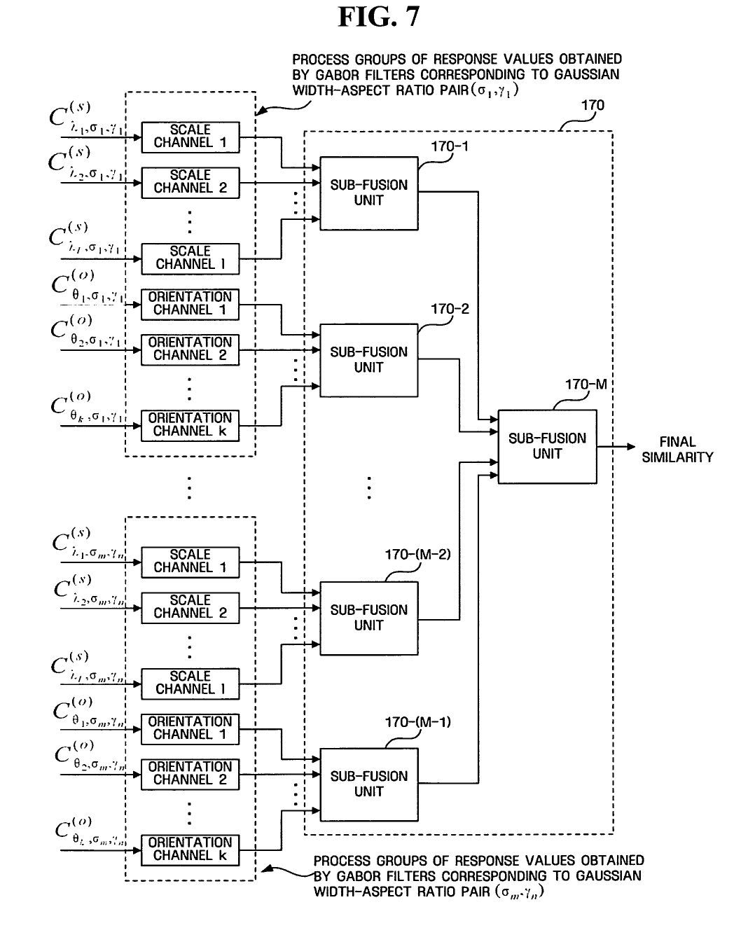

The fusion unit 170 fuses similarities obtained by the similarity calculation unit 160. The fusion unit 170 may primarily the similarities provided by the similarity calculation unit 750 in such a manner that similarities obtained using LDA results that are obtained using a plurality of response value groups provided by a plurality of Gabor filters having the same scale for each of a plurality of Gaussian width-aspect ratio pairs can be fused together and that similarities obtained using LDA results that are obtained using a plurality of response value groups provided by a plurality of Gabor filters having the same orientation for each of the Gaussian width-aspect ratio pairs can be fused together. Thereafter, the fusion unit 170 may secondarily fuse the results of the primary fusing, thereby obtaining a final similarity. For this, the fusion unit 170 may include a plurality of sub-fusion units 170-1 through 170-(M−1), and this will hereinafter be described in detail with reference to FIG. 7.

FIG. 7 illustrates N channels, including a plurality of first through l-th scale channels and a plurality of first through k-th orientation channels. The N channels illustrated in FIG. 7 may be interpreted as N modules into which the LDA units 150-1 through 150-N and the sub-similarity calculation units 160-1 through 160-N are respectively integrated. Referring to FIG. 7, each of the channels receives a response value group output by the classification unit 150, and outputs a similarity. In detail, referring to the channels illustrated in FIG. 7, those which respectively receive groups of response values output by a plurality of Gabor filters having the same scale are scale channels, and those which respectively receive groups of response values output by a plurality of Gabor filters having the same orientation are orientation channels. Each of the response value groups respectively received by the channels illustrated in FIG. 7 may be defined by Equations (2) and (3).

The scale channels and the orientation channels illustrated in FIG. 7 may be provided for each of a plurality of Gaussian width-aspect ratio pairs. The sub-fusion units 170-1 through 170-(M−1) primarily fuse similarities output by the scale channels provided for each of the Gaussian width-aspect ratio pairs, and primarily fuse similarities output by the orientation channels provided for each of the Gaussian width-aspect ratio pairs. Thereafter, the sub-fusion unit 170-M secondarily fuses the results of the primary fusing sub-fusion units 170-1 through 170-(M−1), thereby obtaining a final similarity.

The fusion unit 170 may obtain the final similarity using a weighted summation method. In this case, a primary fusion operation and a secondary fusion operation performed by the fusion unit 170 may be respectively represented by Equations (4) and (5):

$$\begin{matrix}{S}_{σ , γ}^{( s )} = {\sum }_{λ} {S}_{λ , σ , γ}^{( s )} \cdot {w}_{λ , σ , γ}^{( s )} \\ {S}_{σ , γ}^{( o )} = {\sum }_{θ} {S}_{θ , σ , γ}^{( o )} \cdot {w}_{θ , σ , γ}^{( o )} ; and & ( 4 ) \\ {S}^{( total )} = {\sum }_{σ , γ} ( {S}_{σ , γ}^{( s )} \cdot {w}_{σ , γ}^{( s )} + {S}_{σ , γ}^{( o )} \cdot {w}_{σ , γ}^{( o )} ) . & ( 5 )\end{matrix}$$

Here, S represents similarity, w represents a weight value, parenthesized superscript s and parenthesized superscript o indicate an association with scale and orientation, respectively, S^{(total)} represents a final similarity, and θ, λ, σ, and γ respectively represent the orientation, scale, Gaussian width, and aspect ratio of a Gabor filter.

The weight value w in Equations (4) and (5) may be set for each of a plurality of channels in such a manner that a similarity output by a channel that achieves a high recognition rate when being used to perform face recognition can be more weighted than a similarity output by a channel that achieves a low recognition rate when being used to perform face recognition. The weight value w may be experimentally determined.

The weight value w may be determined according to equal error rate (EER). EER is an error rate occurring when false rejection rate and false acceptance rate obtained by performing face recognition become equal. The lower the EER is, the higher the recognition rate becomes. Thus, the inverse of the EER may be used as the weight value w. In this case, the weight value w in Equations (4) and (5) may be substituted for by

$$\frac{k}{EER}$$

where k is a constant for normalizing the weight value w.

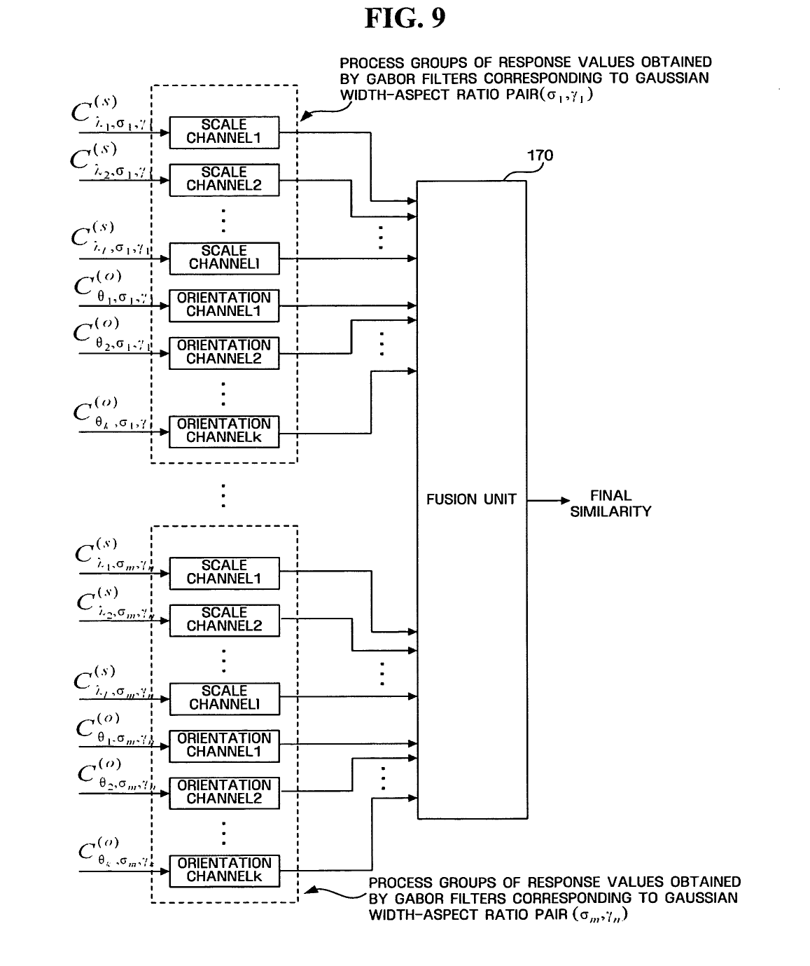

Referring to FIG. 7, the fusion unit 170 may fuse the similarities output by the first through l-th scale channels and the first through k-th orientation channels for each of the Gaussian width-aspect ratio pairs using a method other than the one set forth herein. For example, referring to FIG. 8, the fusion unit 170 may primarily fuse similarities output by a plurality of channels provided for each of the Gaussian width-aspect ratio pairs regardless of whether the channels are scale channels or orientation channels, and secondarily fuse the results of the primary fusing, thereby obtaining a final similarity. Alternatively, referring to FIG. 9, the fusion unit 170 may fuse all the similarities output by the channels provided for each of the Gaussian width-aspect ratio pairs. However, the fusion unit 170 may fuse the similarities obtained by the similarity calculation unit 160 using a method other than those set forth herein.

Referring to FIG. 1, the determination unit 180 classifies the input image using the final similarity provided by the fusion unit 170. In detail, if the final similarity provided by the fusion unit 170 is higher than a predefined critical value, the determination unit 180 may determine that a query face image renders the same person as that of a target face image, and decide to accept the query face image. Conversely, if the final similarity provided by the fusion unit 170 is lower than the predefined critical value, the determination unit 180 may determine the query face image renders a different person from the person rendered in the target face image, and decide to reject the query face image. FIG. 1 illustrates the fusion unit 170 and the determination unit 180 as being separate blocks. However, the fusion unit 170 may be integrated into the determination unit 180. In this case, the determination unit 180 recognizes a face image according to similarities provided by the similarity calculation unit 160.

The term “unit” may be a kind of module. The term “module”, as used herein, means, but is not limited to, a software or hardware component, such as a Field Programmable Gate Array (FPGA) or Application Specific Integrated Circuit (ASIC), which performs certain tasks. A module may be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be integrated into fewer components and modules or further divided into additional components and modules.

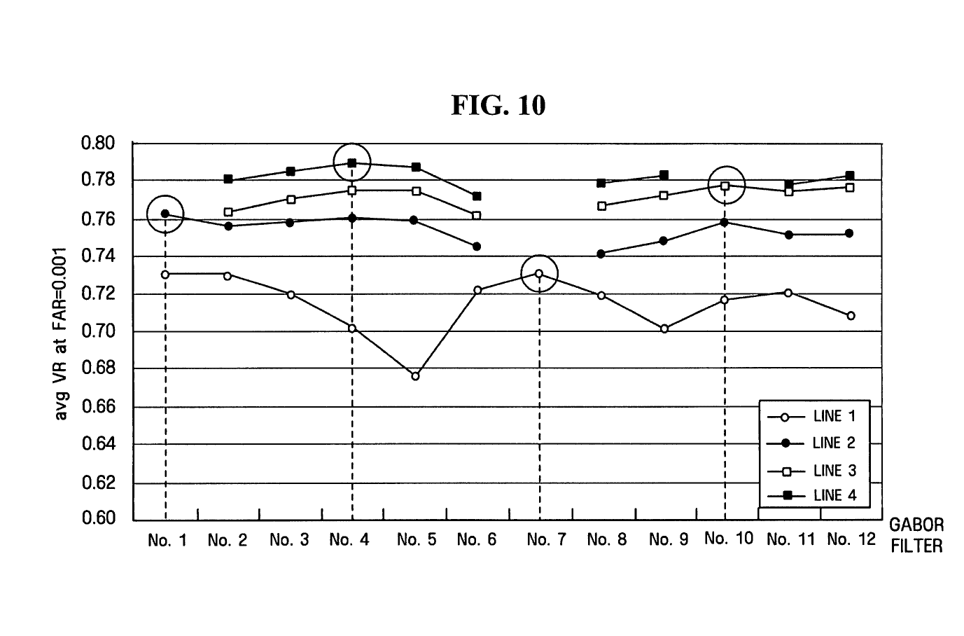

In order to realize a face recognition apparatus which can achieve high face recognition rates and can reduce the number of Gabor filters used by the Gabor filter unit 130, a predefined number of Gabor filters that are experimentally determined to considerably affect the performance of the face recognition apparatus are chosen from a plurality of Gabor filters, and the Gabor filter unit 130 may be allowed to use only the chosen Gabor filters. A method of choosing a predefined number of Gabor filters from a plurality of Gabor filters according to the Gaussian width-aspect ratio pairs of the plurality of Gabor filters will hereinafter be described in detail with reference to Table 1 and FIG. 10.

TABLE 1

| Gabor | |
|---|---|
| Filter No. | (Gaussian Width, Aspect Ratio) |
| 1 | $( \frac{1}{2} λ , \frac{1}{2} )$ |
| 2 | $( \frac{1}{2} λ , \frac{1}{\sqrt{2}} )$ |
| 3 | $( \frac{1}{2} λ , 1 )$ |
| 4 | $( \frac{1}{2} λ , \sqrt{2} )$ |
| 5 | $( \frac{1}{2} λ , 2 )$ |
| 6 | $( \frac{1}{\sqrt{2}} λ , \frac{1}{\sqrt{2}} )$ |
| 7 | $( \frac{1}{\sqrt{2}} λ , 1 )$ |
| 8 | $( \frac{1}{\sqrt{2}} λ , \sqrt{2} )$ |
| 9 | $( \frac{1}{\sqrt{2}} λ , 2 )$ |
| 10 | (λ, 1) |
| 11 | (λ, √2) |
| 12 | (λ, 2) |

FIG. 10 is a graph illustrating experimental results obtained when choosing four Gabor filters from a total of twelve Gabor filters respectively having twelve Gaussian width-aspect ratio pairs presented in Table 1. In Table 1, λ represents the scale of a Gabor filter, and FIG. 10 illustrates experimental results obtained when a false acceptance rate is 0.001.

Face recognition rate was measured by using the first through twelfth Gabor filters separately, and the results of the measurement are represented by Line 1 of FIG. 10. Referring to Line 1 of FIG. 10, the seventh Gabor filter achieves the highest face recognition rate.

Thereafter, face recognition rate was measured by using each of the first through sixth and eighth through twelfth Gabor filters together with the seventh Gabor filter, and the results of the measurement are represented by Line 2 of FIG. 10. Referring to Line 2 of FIG. 10, the first Gabor filter achieves the highest face recognition rate when being used together with the seventh Gabor filter.

Thereafter, face recognition rate was measured by using each of the second through sixth and eighth through twelfth Gabor filters together with the first and seventh Gabor filters, and the results of the measurement are represented by Line 3 of FIG. 10. Referring to Line 3 of FIG. 10, the tenth Gabor filter achieves the highest face recognition rate when being used together with the first and second Gabor filters.

Thereafter, face recognition rate was measured by using each of the second through sixth, eighth, ninth, eleventh, and twelfth Gabor filters together with the first, second, and tenth Gabor filters, and the results of the measurement are represented by Line 4 of FIG. 10. Referring to Line 4 of FIG. 10, the fourth Gabor filter achieves the highest face recognition rate when being used together with the first, second, and tenth Gabor filters.

In this manner, four Gaussian width-aspect ratio pairs that result in high face recognition rates when being used together can be chosen from the twelve Gaussian width-aspect ratio pairs. Then, a face recognition apparatus comprising a Gabor filter unit 130 that only uses Gabor filters corresponding to the chosen four Gaussian width-aspect ratio pairs can be realized. However, it is to be understood that this merely a non-limiting example. In general, as the number of Gabor filters used by the Gabor filter unit 130 increases, the degree to which face recognition rate is increased decreases, and eventually, the face recognition rate saturates around a specified level. Given all this, the Gabor filter unit 130 may appropriately determine the number of Gabor filters to be used and Gabor filter parameter values in advance through experiments in consideration of the computing capabilities of the face recognition apparatus and the characteristics of an environment where the face recognition apparatus is used.

A similar method to the method of choosing a predefined number of Gabor filters from among a plurality of Gabor filters described above with reference to Table 1 and FIG. 10 can be effectively applied to Gabor filter scale and orientation. In detail, referring to FIG. 7, a scale channel-orientation channel pair comprising a scale channel and an orientation channel that are experimentally determined in advance to considerably affect face recognition rate may be chosen for each of the Gaussian width-aspect ratio pairs or for all the Gaussian width-aspect ratio pairs. Then, a face recognition apparatus comprising a Gabor filter unit 130 that only uses Gabor filters corresponding to the chosen scale channel-orientation channel is realized, thereby achieving high face recognition rates with fewer Gabor filters.

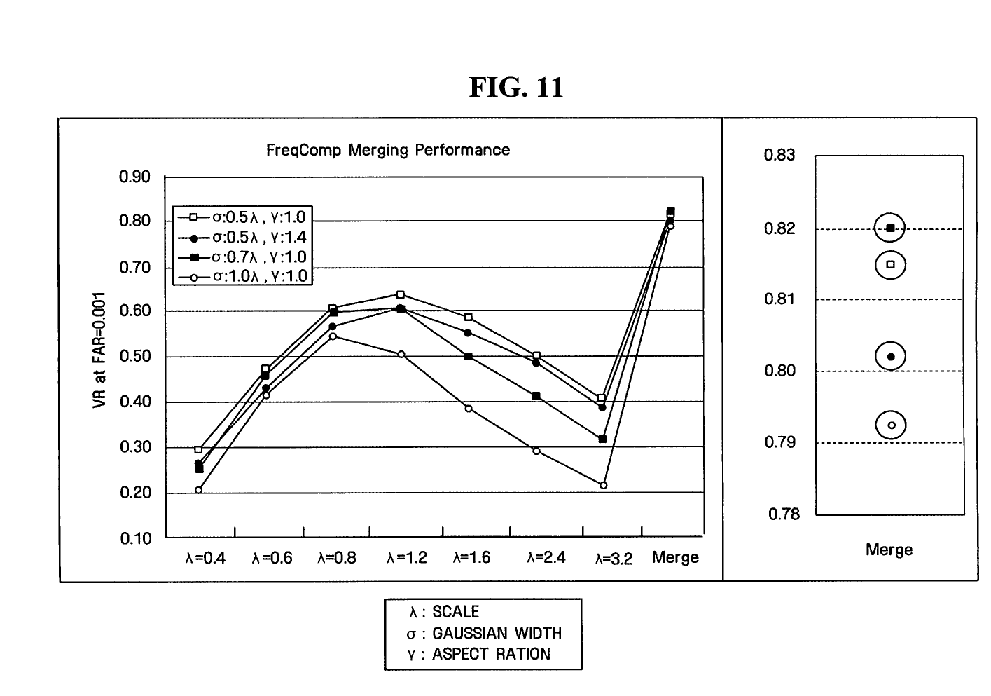

As described above, according to the present embodiment, a plurality of response values obtained from a face image by a plurality of Gabor filters are classified into one or more response value groups, and LDA is performed on each of the response value groups, whereas, in the conventional art, LDA training is performed on all of a plurality of response values obtained from a face image by a plurality of Gabor filters. According to the present embodiment, the response value groups are complementary to one another, and this will hereinafter be described in detail with reference to FIGS. 11 through 13.

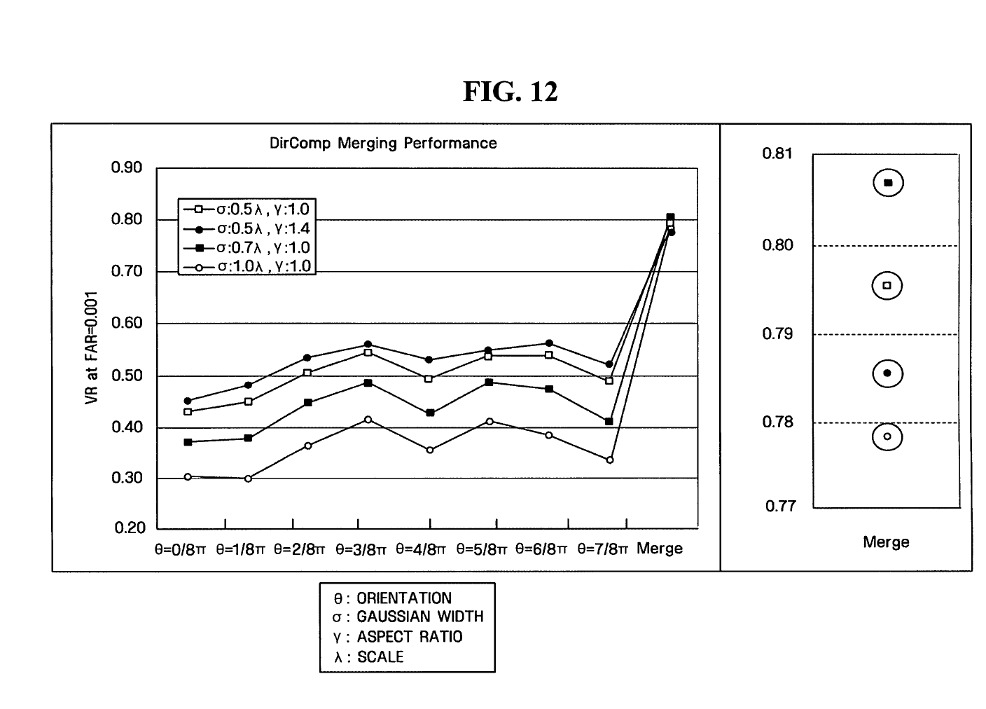

FIG. 11 is a graph illustrating face recognition rates obtained by using seven scale channels separately, and FIG. 12 is a graph illustrating face recognition rates obtained by using eight orientation channels separately. Referring to FIGS. 11 and 12, four lines represent experimental results obtained using the four Gaussian width-aspect ratio pairs chosen from the twelve Gaussian width-aspect ratio pairs presented in Table 1 according to the experimental results illustrated in FIG. 10. In addition, the experimental results illustrated in FIGS. 11 and 12 were obtained using the numerical values illustrated in FIG. 5A.

Referring to FIGS. 11 and 12, face recognition rates obtained by using a plurality of channels separately are generally low. On the other hand, face recognition rates obtained by using a plurality of channels together according to the present embodiment amount to almost 80%, as indicated by a section “Merge” illustrated in FIGS. 11 and 12.

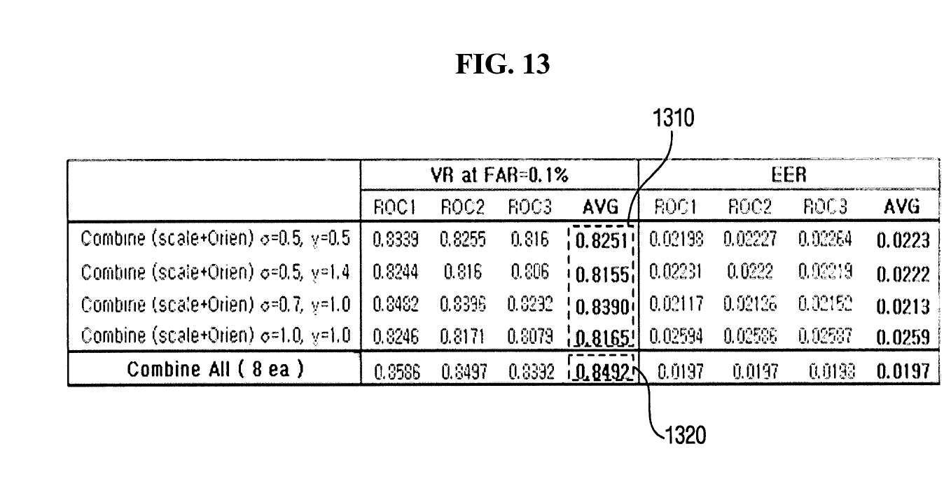

A face recognition apparatus combining a plurality of scale channels and a plurality of orientation channels for each of the chosen four Gaussian width-aspect ratio pairs can achieve a face recognition rate of higher than 80%, as indicated by reference numeral 1310 of FIG. 13. In addition, a face recognition apparatus combining the scale channels and the plurality of orientation channels for all the chosen four Gaussian width-aspect ratio pairs can achieve as high a face recognition rate as 85%, as indicated by reference numeral 1320 of FIG. 13.

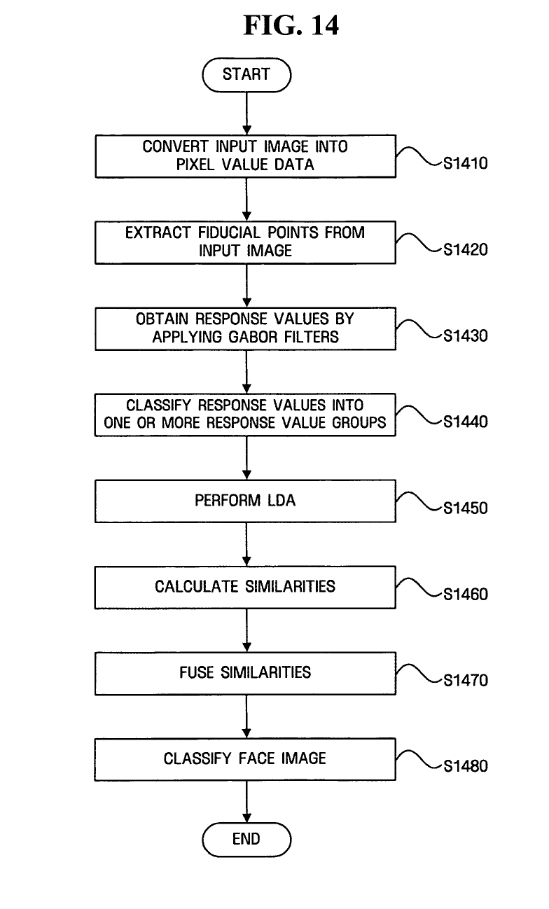

FIG. 14 is a flowchart illustrating a face recognition method according to an embodiment of the present invention. The face recognition method is described with concurrent reference to the face recognition apparatus illustrated in FIG. 1, for ease of explanation only.

Referring to FIG. 14, in operation S1410, the image reception unit 110 receives an input image, and converts the input image into pixel value data. In operation S1420, the normalization unit 120 extracts a predefined number of fiducial points from the result of the conversion performed by the image reception unit 110. In order to extract the predefined number of fiducial points from the result of the conversion performed by the image reception unit 110, the normalization unit 120 may perform a plurality of operations on the input image, and the operations may include a face detection operation, a face image extraction operation, a face image resizing operation, and a face image pre-processing operation, as described above with reference to FIG. 4.

In operation S1430, once the predefined number of fiducial points are extracted from the result of the conversion performed by the image reception unit 110, the Gabor filter unit 130 applies a plurality of Gabor filters having different properties to the specified number of fiducial points, thereby obtaining a plurality of response values. These properties are determined by various parameters. Examples of the parameters of Gabor filters include orientation, scale, Gaussian width, and aspect ratio.

Thereafter, in operation S1440, the classification unit 140 classifies the response values into one or more response value groups. The classification unit 140 may classify the response values in such a manner that a plurality of response values obtained from a specified group of fiducial points and a plurality of response values obtained from the remaining fiducial points belong to different response value groups.

Thereafter, in operation S1450, the LDA unit 150 performs LDA on each of the response value groups, thereby obtaining LDA results. In operation S1460, the similarity calculation unit 160 compares the LDA results with LDA results obtained by performing operations S1410 through S1450 on a face image other than the input image, and calculates similarities according to the results of the comparison. The face image other than the input image is a reference face image which is used to determine whether a person rendered in the input image is a registered user.

Thereafter, in operation S1470, the fusion unit 170 fuses the similarities obtained by the similarity calculation unit 160 using the aforementioned similarity fusion method.

In operation S1480, the determination unit 180 classifies the input image using the result of the fusion performed by the fusion unit 170.

Embodiments of the present invention can be written as code/instructions/computer programs and can be implemented in general-use digital computers that execute the code/instructions/computer programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

According to the above-described embodiments of present invention, it is possible to enhance the performance of face recognition systems and methods by using Gabor filters.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A face recognition apparatus comprising:
a Gabor filter unit which obtains a plurality of response values by applying a plurality of Gabor filters having different properties to a plurality of fiducial points extracted from an input face image;
a linear discriminant analysis (LDA) unit which obtains first LDA results by performing LDA on each of a plurality of response value groups into which the response values of the plurality of response values are classified;
a similarity calculation unit which calculates similarities between the first LDA results and second LDA results obtained by performing LDA on a face image other than the input face image; and
a determination unit which classifies the input face image according to the similarities.

2. The face recognition apparatus of claim 1, wherein the Gabor filter properties are determined by at least one parameter including an orientation, a scale, a Gaussian width, and an aspect ratio.

3. The face recognition apparatus of claim 2, further comprising a classification unit which classifies the response values into at least one response value group according to the Gabor filter properties.

4. The face recognition apparatus of claim 3, wherein the classification unit classifies the response values so that a plurality of response values obtained from a group of fiducial points and a plurality of response values obtained from remaining fiducial points belong to different response value groups.

5. The face recognition apparatus of claim 3, wherein the classification unit classifies the response values for each of a plurality of Gaussian width-aspect ratio pairs so that a plurality of response values output by a plurality of Gabor filters corresponding to a same orientation are groupable together and that a plurality of response values output by a plurality of Gabor filters corresponding to a same scale are groupable together.

6. The face recognition apparatus of claim 1, further comprising a fusion unit which fuses the similarities, wherein the determination unit classifies the input face image according to a result of the fusion.

7. The face recognition apparatus of claim 6, wherein the fusion unit primarily fuses the similarities for each of a plurality of Gaussian width-aspect ratio pairs so that similarities output via a plurality of Gabor filters corresponding to a same scale are fusable and that similarities output via a plurality of a plurality of Gabor filters corresponding to a same orientation are fusable together, and secondarily fuses results of the primary fusion.

8. The face recognition apparatus of claim 6, wherein the fusion unit primarily fuses the similarities so that similarities output via a plurality of Gabor filters corresponding to a same Gaussian width-aspect ratio pair are fusable, and secondarily fuses results of the primary fusion.

9. The face recognition apparatus of claim 6, wherein the fusion unit fuses the similarities by calculating a weighted sum of the similarities.

10. The face recognition apparatus of claim 9, wherein a weight used in the calculation of the weighted sum of the similarities is an equal error rate (EER).

11. A face recognition method comprising:
obtaining a plurality of response values by applying a plurality of Gabor filters having different properties to a plurality of fiducial points extracted from an input face image;
obtaining linear discriminant analysis (LDA) results by performing LDA on each of a plurality of response value groups into which the response values of the plurality of response values are classified;
calculating similarities between the first LDA results and second LDA results obtained by performing LDA on a face image other than the input face image; and
classifying the input face image according to the similarities.

12. The face recognition method of claim 11, wherein the Gabor filters properties are determined by at least one parameter including an orientation, a scale, a Gaussian width, and an aspect ratio.

13. The face recognition method of claim 12, wherein the performing of LDA comprises classifying the response values into at least one response value group according to the Gabor filter properties.

14. The face recognition method of claim 13, wherein the performing of LDA further comprises classifying the response values so that a plurality of response values obtained from a group of fiducial points and a plurality of response values obtained from the remaining fiducial points belong to different response value groups.

15. The face recognition method of claim 13, wherein the classifying further comprises classifying the response values for each of a plurality of Gaussian width-aspect ratio pairs in such a manner that a plurality of response values output by a plurality of Gabor filters corresponding to the same orientation are groupable together and that a plurality of response values output by a plurality of Gabor filters corresponding to the same scale are groupable together.

16. The face recognition method of claim 11 further comprising fusing the similarities, wherein the classifying comprises classifying the input face image according to a result of the fusion.

17. The face recognition method of claim 16, wherein the fusing comprises:
primarily fusing the similarities for each of a plurality of Gaussian width-aspect ratio pairs in such a manner that similarities output via a plurality of Gabor filters corresponding to the same scale are fusable and that similarities output via a plurality of a plurality of Gabor filters corresponding to the same orientation are fusable together; and
secondarily fusing the results of the primary fusion.

18. The face recognition method of claim 16, wherein the fusing comprises:
primarily fusing the similarities in such a manner that similarities output via a plurality of Gabor filters corresponding to the same Gaussian width-aspect ratio pair are fusable; and
secondarily fusing the results of the primary fusion.

19. The face recognition method of claim 16, wherein the fusing comprises fusing the similarities by calculating a weighted sum of the similarities.

20. The face recognition method of claim 19, wherein a weight used in the calculation of the weighted sum of the similarities is an equal error rate (EER).

21. A computer-readable storage medium encoded with processing instructions for causing a processor to execute the method of claim 11.

22. A face recognition apparatus comprising:
a normalization unit extracting a face image from an input image, and extracting a set of fiducial points from the extracted face image;
a Gabor filter unit applying a plurality of Gabor filters having different properties to the extracted fiducial points to yield response values;
a classification unit classifying the response values into at least one response value group based on the Gabor filter properties;
a linear discriminant analysis (LDA) unit generating first LDA results by performing LDA on each response value group;
a similarity calculation unit calculating similarities between the first LDA results and training data generated by performing LDA on a reference face image; and
a determination unit classifying the input face image according to the similarities.

23. The apparatus of claim 22, wherein the normalization unit includes a face recognition unit detecting a specified portion of the input image, a face image extraction unit extracting the face image from the input image based on the detected specified portion, and a fiducial point extraction unit extracting the fiducial points.

24. The apparatus of claim 23, wherein the normalization unit includes a face image resizing unit resizing the extracted face image so that a size of the input image does not affect the response values.

25. The apparatus of claim 22, wherein sets of Gabor filters are applied to at least one of the fiducial points.

26. The apparatus of claim 22, wherein only at least one selected set of a plurality of available Gabor filters is used by the Gabor filter unit, the at least one selected set being a set that maximizes face recognition.
